(19) United States
(12) Patent Application Publication
(10) Pub. No.: US 2011/0105648 A1
(43) Pub. Date: May 5, 2011

(54) PROCESS OF COPOLYMERIZATION IN EMULSION OF 1-ALKENES AND VINYL ESTERS WITH HIGH CONVERSION AND THEIR USE

(76) Inventors: Ulrike Peter, Aubervilliers (FR); Roland Reeb, Aubervilliers (FR); Lisa Kimes Jones, Stafford, TX (US)

(21) Appl. No.: 12/921,751

(22) PCT Filed: Mar. 26, 2009
(86) PCT No.: PCT/EP2009/002213

§ 371 Date: Jan. 17, 2011

(30) Foreign Application Priority Data
Apr. 10, 2008 (EP) 08007102.0

(51) Int. Cl. C08F 2/24; C08F 2/44; C04B 16/00

(52) U.S. Cl. 524/5; 524/853; 524/854; 524/819; 524/823

(57) ABSTRACT

New process conditions are described and more particularly emulsion polymerization of compositions which are based on copolymers of vinyl acetate, straight chain α-olefin and an optional third different olefinically-unsaturated co-monomer in which the α-olefin is emulsified prior to the addition into the polymerization mixture.

### RELATED APPLICATION DATA

This application claims the benefit of PCT Application PCT/EP2009/002213 with International Filing Date of Mar. 26, 2009, published as WO 2009/124661 A1, which further claims priority to European Patent Application No. EP08007102.0 filed Apr. 10, 2008, the entire contents of both are hereby incorporated by reference.

### DESCRIPTION

This invention is directed to new process conditions and more particularly to the emulsion polymerization of compositions which are copolymers of vinyl acetate, straight chain α-olefin and optionally a third, different olefinically-unsaturated co-monomer in which the α-olefin is emulsified prior to the addition into the polymerization mixture. This invention is furthermore directed to the application of the resulting copolymers in adhesives and coatings, and more particularly in combination with mineral binders like cement or gypsum. It can also be used in cement-free blends, containing mineral fillers and organic and/or inorganic admixtures.

Copolymers of vinyl acetate have found wide use in a number of applications and particularly in the form of aqueous latices as coating compositions such as paints and adhesives, as well as redispersable powder for cement additives and adhesives. In specific application fields, the inherent properties of the vinyl acetate require plasticization. Vinyl acetate copolymers have thus been plasticized by the use of external plasticizers of various chemistries. Vinyl acetate polymers can also be plasticized by means of internal plasticizers with comonomers such as the acrylates, vinylic esters with long alkyl chains or maleic esters, ethylene, etc. Such comonomers also serve to alter and diminish the undesirable properties of the polyvinyl acetate itself, such as its saponification in alkaline environment.

It has now been found that by copolymerizing a relatively low amount of a straight chain α-olefin with a predominant amount of vinyl acetate and eventually one or more further comonomers, advantageous properties can be imparted to the resulting polymer.

The chemical behavior of α-olefins in radical polymerization is different from other vinyl monomers. Using the mixture of 10 to 20% of α-olefin and vinyl acetate for example will lead to low incorporation of the α-olefin into the polymer. This is due to the formation of a resonance stabilized allylic radical after transfer of the growing polymer chain radical to the α-olefin monomer, which reduces the overall conversion of the monomers. Several process conditions have been suggested over the past decades in order to improve the conversion. The U.S. Pat. No. 3,689,432 claims that the use of t-dodecyl mercaptan and zinc formaldehyde sulfoxylate is an option. In U.S. Pat. No. 3,755,237 the presence of specific unsaturated monomer helps to increase the incorporation of the α-olefins when used in low percentage and for α-olefin of up to 9 carbon atoms so the mandatory presence of a third olefin works in limited number of specific cases. The GB 1,104,536 and GB 1,111,168 are limited to the preparation of latices containing α-olefins with 6 or 8 carbon atoms. More recent work as in WO 2007/113180 or WO 2007/012616 propose that the presence of a seed of polystyrene increase the conversion for α-olefins with carbon atoms chain from 5 to 12 with working examples based on 1-octen.

As shown in the prior art, the interest of the industry to have a process that is suitable for the preparation of latices with a high level of α-olefin conversion is still present.

Therefore, it is an object of the present invention to provide a means for conducting the emulsion copolymerization of vinyl acetate and at least one α-olefin, with high level of olefin conversion of >90%, preferably >95% and more preferably >98%.

We have found that the incorporation of high level of α-olefins with carbon atoms chain of 9 to 25 units are successfully reacted with vinyl acetate by adding the pre-emulsified α-olefin in presence of a surfactant and/or a colloid protecting agent.

The pre-emulsion comprises the α-olefin, optionally other unsaturated polymerizable monomers, a colloid protecting agent such as PVOH (which is 85-99 mole % hydrolyzed, especially 87 to 89% mole % hydrolyzed), surfactants and antifoaming agents. The α-olefin is introduced in a level from 1 to 25 weight %, with preferred range between 5 to 15 wt % on total monomer content. The other unsaturated polymerizable monomers can be selected from vinyl acetate, acrylic or methacrylic alkyl esters and or cycloalkyl esters, ethylene, vinyl ester such as VeoVa (vinyl ester of tertiary branched acid, ex Hexion Specialty Chemicals), vinyl ester of lauric acid, vinyl ester of 2 ethyl hexanoic acid, and mono or diesters of maleic acid, and combinations of them.

The α-olefin carbon chain used in the invention will be out of 9 to 25 units, with preferably 12 to 18 units.

With this process we achieve particles sizes of the polymer distribution within the range 0.1μ-10μ, and preferentially between 0.2μ and 4μ. The thus obtained latices and their resulting redispersible powders show high Tg while low MFFT, which is particularly interesting in composite materials like ceramic tile adhesives, but also in adhesives for paper, wood, carpets, floor coverings, etc.

### EXAMPLES

### General Procedure for Latex Preparation

A 6 liters reactor is equipped with a condenser and mechanical agitator, and is charged with 1430 g of demineralized (demi) water, 742.5 g of vinyl acetate, 19 g of a perester and 1247 g of the pre-emulsion consisting of: 355 g of demi water, 532 g of a PVOH 5/88 solution at 24.9% solids content, 20.3 g of anionic surfactant, 67.5 g of vinyl acetate, 2.2 g of anti foaming agent and 270 g of α-olefin in C16. The pre-emulsion is obtained by using a high shear homogenizer of Ultraturax type, the reactor is further flushed with nitrogen and gradually heated up to 66° C., when temperature is reached the solution of initiator is added to the reactor, the initiator solution consisting in 5.4 g of potassium persulfate and 5.4 g of sodium bicarbonate in 60.7 g of demi water. After complete addition the temperature is raised to 90° C., after 1 h and 15 minutes a solution of 54 g water, 1.1 g of potassium persulfate and 6.8 g of sodium bicarbonate is added in continuous. After 2 h and 25 minutes a second addition of vinyl acetate (1485 g) over a period of 5 h is added and also a solution consisting in 101 g of demi water and 7.7 g of alkylhydroperoxide as 70% solution and also a solution of 146 g of demi water and 16.2 g of sodium metabisulfite. We do also a spot addition of 12 g of a perester 30 minutes after the end of monomer feeding.

During the polymerization, the temperature is maintained between 81 to 88° C., and at the end the temperature is raised to 92-93° C. After a total batch time of 9 h the reactor is cooled down to room temperature.

Latex properties of the above example A is given in the next table together with examples B, D, E and F according to the invention and example C as reference.

For examples B and F a third monomer is used (10 weight % on total monomers of VeoVa 10 ex Hexion Specialty Chemicals).

TABLE 1
Properties of the emulsions

| | | | Visco | Part. | | | Δ | | Olefin |
|---|---|---|---|---|---|---|---|---|---|
| | C16 | VeoVa | mPa s | size μm | Tg | MFFT | ° C. | Residual | conversion % |
| Ex. | % | % | ** | *** | ° C. | ° C. | **** | olefin ppm | ***** |
| A | 10 | — | 2665 | 0.4 | 31 | 6.4 | 24.6 | 236 | 99.6 |
| B | 10 | 10 | 3160 | 0.4 | 24 | 4.8 | 19.2 | 67 | 99.9 |
| C * | 15 | — | 860 | 4.5 | 32 | 10.4 | 21.6 | 31000 | 58 |
| D | 15 | — | 1670 | 0.4 | 30 | 2.4 | 27.6 | 5000 | 96 |
| E | 10 | — | 3290 | 1.9 | 30 | 6.2 | 23.8 | 1000 | 98.3 |
| F | 10 | 10 | 3500 | 1.8 | 24 | 4.6 | 19.4 | 950 | 98.4 |

* comparative example: α-olefin is not pre-emulsified and added with the other ingredients directly in the reactor
** determined according to ISO 2555
*** D50 in μm determined with Malvern Mastersizer 2000
**** [symbol] [symbol] Tg − MFFT
***** residual monomer measured by Head-Space gas chromatography
MFFT = minimum film forming temperature.

### Redispersable Powder Based on the Latex A, B, E or F:

The redispersable powder is obtained by spray-drying of the latex in presence of kaolin, silica or talc and polyvinyl alcohol (PVOH). The typical composition of the final powder is as follows:
Latex A, B, E or F: 79-86 weight %
PVOH: 4-6 weight %
Anticaking agents: 10-15 weight %

Properties of the redispersable powder in water:
Latex powder A (based on Latex A): particle size d50: from 40 to 160 microns (measured with a Malvern Mastersizer 2000), Tg 31° C. and MFFT 6° C.;
Latex powder B (based on Latex B): particle size d50: from 40 to 160 microns, Tg 24° C. and MFFT 4° C.
Latex powder E (based on Latex E): particle size d50: from 40 to 160 microns, Tg 30° C. and MFFT 6° C.
Latex powder F (based on Latex F): particle size d50: from 40 to 160 microns, Tg 24° C. and MFFT 4° C.

### Formulations of 2K Adhesive Cement:

Solids:
Cement OPC CEM I 52.5: 33%
Sand: 61.7%
Calcium carbonate: 1%
Cellulose ether: 0.3%
Latex dispersion (dry extract): 4%
Water/Solid: 24%

The evaluation is done according to the EN standard for tile adhesives (EN 12002 and EN 12004) after an application of a thin mortar layer on a concrete tile. The comparative examples are based on industrial vinylic copolymers (Latex R1 et R2) on 50 to 80 weight % of vinyl acetate (Va) and from 20 to 50% of other vinylic esters with long alkyl chain or maleic esters.

The Table 2 reports the adhesion values obtained for the bicomponent system used the latices in their liquid form, and after dry storage and after more severe storage (wet and hot storage, and after a long open time). Depending on the storage conditions, the latices according to the invention lead to improved properties as compared to the current industrial standards. In particular, the latices according to the invention show improved properties as compared to the industrial standard R1.

TABLE 2

| | Δ | adhesion | adhesion | adhesion | open time | open time |
|---|---|---|---|---|---|---|
| Latex | ° C. | dry*/MPa | humid*/MPa | hot*/MPa | 20 min | 30 min |
| A | 25 | 2.37 ± 0.2 | 1.42 ± 0.2 | 2.06 ± 0.25 | 1.77 ± 0.1 | 0.96 ± 0.2 |
| B | 19 | 1.97 ± 0.2 | 1.68 ± 0.2 | 1.91 ± 0.25 | 1.56 ± 0.1 | 0.73 ± 0.2 |
| R1** | 9 | 1.64 ± 0.2 | 1.66 ± 0.2 | 1.16 ± 0.25 | 1.30 ± 0.1 | 1.09 ± 0.2 |
| R2*** | 10 | 2.42 ± 0.2 | 1.10 ± 0.2 | 2.32 ± 0.25 | 1.58 ± 0.1 | 1.54 ± 0.2 |

*after storage and according EN12004
**Tg: 15° C., MFFT: 6° C., commercial reference 1
***Tg: 16° C., MFFT: 7° C., commercial reference 2 [symbol] [symbol]
Tg − MFFT

### Formulations of C2-Type Drymix Tile Adhesives:

The evaluation is performed according to the EN standard 12004 in a formulation using 3% latex powder:

Drymix Mortar:
Cement OPC CEM I 52.5: 35%
Sand: 59.35%
Calcium carbonate: 2%
Cellulose ether: 0.35%
Calcium formate: 0.3%
Latex powder: 3%
Water/Solid: 24%

The results are compared to the powders of the commercial vinylic copolymers Latex R1 et R2 (50 to 80 weight % of vinyl acetate (Va) and from 20 to 50% of other vinylic esters with long alkyl chain or maleic esters).

The Table 3 reports the adhesion values obtained. The latex powder of the present invention leads to mechanical properties which are at least comparable to the current industrial standards.

TABLE 3

| Latex | Δ | adhesion | adhesion | adhesion | open time | open time |
|---|---|---|---|---|---|---|
| powder | ° C. | dry*/MPa | humid*/MPa | hot*/MPa | 20 min | 30 min |
| A | 25 | 1.6 ± 0.1 | 0.8 ± 0.1 | 1.4 ± 0.2 | 1.2 ± 0.3 | 0.5 ± 0.1 |
| R1 | 9 | 1.4 ± 0.1 | 1.0 ± 0.1 | 1.2 ± 0.2 | 0.8 ± 0.3 | 0.2 ± 0.1 |
| R2 | 10 | 1.4 ± 0.1 | 1.0 ± 0.1 | 1.3 ± 0.2 | 1.1 ± 0.3 | 0.5 ± 0.1 |

*after storage and according to EN 12004 [symbol] [symbol]
Tg − MFFT

### Formulations of Flexible Tile Adhesives:

The evaluation is performed according to the EN standards 12002 and 12004 in a formulation using 4% of latex powder:

Drymix Mortar:
Cement OPC CEM I 52.5: 33%
Sand: 61.7%
Calcium carbonate: 1%
Cellulose ether: 0.3%
Latex powder: 4%
Water/Solid: 24%

The Table 4 reports the adhesion and maximum deformation values obtained. The latex powder according to the invention leads to mechanical performances comparable to the considered references.

TABLE 4

| Latex | Δ | adhesion | adhesion | adhesion | open time | open time | max. |
|---|---|---|---|---|---|---|---|
| powder | ° C. | dry*/MPa | humid*/MPa | hot*/MPa | 20 min | 30 min | def.**/mm |
| A | 25 | 2.7 ± 0.2 | 1.5 ± 0.1 | 2.5 ± 0.3 | 1.9 ± 0.3 | 0.5 ± 0.2 | 2.2 ± 0.2 |
| R1 | 9 | 2.1 ± 0.2 | 1.6 ± 0.1 | 1.5 ± 0.3 | 1.1 ± 0.3 | 1.1 ± 0.2 | 2.1 ± 0.2 |
| R2 | 10 | 2.6 ± 0.2 | 1.8 ± 0.1 | 2.6 ± 0.3 | 1.6 ± 0.3 | 1.1 ± 0.2 | 2.2 ± 0.2 |

*after storage and according to EN 12004
**according to EN 12002
Δ [symbol] Tg − MFFT

1. A process for forming an emulsion composition, comprising:
providing vinyl acetate and at least one α-olefin to a vessel, wherein the at least one α-olefin is provided to the vessel pre-emulsified in the presence of at least a surfactant, a colloid protecting agent, or both; and
co-polymerizing the vinyl acetate and at least one α-olefin.

2. (canceled)

3. The process of claim 1, wherein the α-olefin comprises a chain of 9 to 25 carbon atoms.

4. The process of claim 1, wherein the α-olefin is provided at a level from 1 to 25 weight %.

5. The process of claim 1, wherein the conversion level of α-olefin is greater than 90%.

6. The process of claim 11, wherein the one or more unsaturated polymerizable monomers are selected from the group consisting of acrylic or methacrylic alkyl esters, cycloalkyl esters, mono and diesters of maleic acid, ethylene, vinyl esters of linear or branched saturated or non saturated monocarboxylic acids having 2 to 18 carbon atoms, and combinations thereof.

7. The emulsion composition obtained according to claim 1.

8. The emulsion composition of claim 7, wherein the emulsion composition comprises particles sizes of a polymer distribution within the range 0.1μ to 10μ.

9. A redispersible powder comprising a spray-dried emulsion composition of claim 7.

10. (canceled)

11. The process of claim 1, further comprising adding one or more unsaturated polymerizable monomers prior to co-polymerizing.

12. The process of claim 11, wherein the one or more unsaturated polymerizable monomers are added to the pre-emulsified at least one α-olefin prior to the vessel.

13. The process of claim 1, wherein the α-olefin comprises a carbon atoms chain of 12 to 18 carbon atoms.

14. The process of claim 1, wherein the α-olefin is provided in a level from 5 to 15 wt % on total monomer content.

15. The process of claim 1, further comprising spray-drying the emulsion composition to form a redispersable powder.

16. The process of claim 15, wherein the spray-drying is performed in the presence of an anti-caking agent and an colloidal protecting agent.

17. The process of claim 14, further comprising adding the redispersable powder to a cement-containing mixture.

18. The process of claim 1, further comprising adding a second amount of vinyl acetate to the emulsion composition.

19. The process of claim 1, wherein the at least one α-olefin is pre-emulsified in a composition of a colloidal protecting agent, a surfactant, anti-foaming agent, and water.

20. The process of claim 19, wherein the composition further includes one or more unsaturated polymerizable monomers selected from the group consisting of vinyl acetate, acrylic or methacrylic alkyl esters, cycloalkyl esters, mono and diesters of maleic acid, ethylene, vinyl esters of linear or branched saturated or non saturated monocarboxylic acids having 2 to 18 carbon atoms, and combinations thereof.
